(19) United States
(12) Patent Application Publication
(10) Pub. No.: US 2013/0054243 A1
(43) Pub. Date: Feb. 28, 2013

(54) ELECTRONIC DEVICE AND CONTROL METHOD

(71) Applicant: Hajime Ichikawa, Kanagawa (JP)

(72) Inventor: Hajime Ichikawa, Kanagawa (JP)

(73) Assignee: KYOCERA Corporation, Kyoto (JP)

(21) Appl. No.: 13/498,738

(22) PCT Filed: Sep. 28, 2010
(86) PCT No.: PCT/JP2010/066863

§ 371 Date: Oct. 19, 2012

(30) Foreign Application Priority Data
Sep. 28, 2009 (JP) 2009-223531

(51) Int. Cl. G10L 15/00

(52) U.S. Cl. 704/246; 704/E15.001

(57) ABSTRACT

Provided is an electronic device and control method, wherein a simple interface upon utilizing voice recognition can be attained. A cellular phone (1) is provided with a voice recognition unit (30), an execution unit (40) that executes a prescribed application, and an OS (50) that controls the voice recognition unit (30) and the executing unit (40). The executing unit (40) will make an assessment, upon receiving an instruction from the OS (50) to start up the prescribed application, of whether the start-up instruction was based on a result of voice recognition conducted by the voice recognition unit (30) or not, and will select the content to be processed according to the result of this assessment.

### TECHNICAL FIELD

The present invention relates to an electronic device having a voice recognition function and a method of controlling the same.

### BACKGROUND ART

In the past, control of activating a desired function based on a character string obtained as a result of voice recognition has been known (see Patent Document 1). Through the voice recognition function, a user of an electronic device can operate the electronic device without performing a key operation when the key operation is difficult or unfamiliar or when his/her hands are full. For example, in an electronic device including various applications, the user can activate a route search application by uttering “route search” or can activate a browser application by uttering “Internet”.

At this time, the electronic device needs to be in an utterance standby state in response to a predetermined operation, recognizes an input voice in this state, and converts the recognized voice into a character string. The electronic device compares the converted character string with a predetermined registered name, and activates an application corresponding to a registered name matching the character string.

In electronic devices, particularly, in mobile electronic devices, in order to save resources, an entity capable of performing reception of an operation input, an event process, or a screen display is often limited to one application. For example, when a voice recognition application is activated from a standby screen (also called “wallpaper”), the standby screen is terminated. Further, when a telephone application is activated by a voice recognition application, the voice recognition application is terminated.

Patent Document 1: Japanese Unexamined Patent Application, Publication No. 2002-351652

### DISCLOSURE OF THE INVENTION

### Problems to be Solved by the Invention

However, when another application is activated from the voice recognition application and then the voice recognition application is terminated as described above, in order to continuously perform an operation by a voice input, a key operation needs to be performed to call the voice recognition application again from a regular menu of the activated application. Thus, convenience of an interface related to voice recognition is insufficient to satisfy users who desire to operate an electronic device using a voice input repeatedly.

An object of the present invention is to provide an electronic device and a control method, which are capable of implementing a simple interface when voice recognition is used.

### Means for Solving the Problems

An electronic device according to the present invention includes a voice recognizing unit, an executing unit that executes a predetermined application, and a control unit that controls the voice recognizing unit and the executing unit, wherein when an activation instruction of the predetermined application is received from the control unit, the executing unit determines whether or not the activation instruction is an instruction based on a voice recognition result from the voice recognizing unit, and selects a processing content according to the determination result.

Preferably, the executing unit changes a user interface of the predetermined application to a voice input user interface when the activation instruction is an instruction based on the voice recognition result.

Preferably, the control unit activates the voice recognizing unit when the executing unit changes the user interface to the voice input user interface.

Preferably, a parameter representing that the predetermined application is activated based on the voice recognition result as the activation instruction is transferred from the voice recognizing unit to the executing unit via the control unit.

Preferably, the voice recognizing unit sets a flag representing that activation is made based on the voice recognition result to ON when the predetermined application is activated, and when it is determined that the flag is set to ON with reference to the flag, the control unit transfers a parameter as the activation instruction representing that the predetermined application is activated based on the voice recognition result to the executing unit.

Preferably, the voice recognizing unit sets a flag representing that activation is made based on the voice recognition result to ON when the predetermined application is activated, and the executing unit determines whether the instruction is based on the voice recognition result from the voice recognizing unit based on whether or not the flag is set to ON with reference to the flag.

Preferably, the control unit sets a flag representing that activation is made based on the voice recognition result to ON when activation of the predetermined application is requested from the voice recognizing unit, and the executing unit determines whether the instruction is based on the voice recognition result from the voice recognizing unit based on whether or not the flag is set to ON with reference to the flag.

A control method according to the present invention is a control method in an electronic device including a voice recognizing unit, an executing unit that executes a predetermined application, and a control unit that controls the voice recognizing unit and the executing unit, and includes an executing step of, at the executing unit, when an activation instruction of the predetermined application is received from the control unit, determining whether or not the activation instruction is an instruction based on a voice recognition result from the voice recognizing unit, selecting a processing content according to the determination result, and executing the predetermined application.

Preferably, in the executing step, a user interface of the predetermined application is changed to a voice input user interface when the activation instruction is an instruction based on the voice recognition result.

Preferably, the control method according to the present invention further includes a step of, at the control unit, activating the voice recognizing unit when the user interface is changed to the voice input user interface in the executing step.

Preferably, the control method according to the present invention further includes a step of transferring a parameter representing that the predetermined application is activated based on the voice recognition result as the activation instruction from the voice recognizing unit to the executing unit via the control unit.

Preferably, the control method according to the present invention further includes a step of, at the voice recognizing unit, setting a flag representing that activation is made based on the voice recognition result to ON when the predetermined application is activated and a step of, when it is determined that the flag is set to ON with reference to the flag, at the control unit, transferring a parameter as the activation instruction representing that the predetermined application is activated based on the voice recognition result to the executing unit.

Preferably, the control method according to the present invention further includes a step of, at the voice recognizing unit, setting a flag representing that activation is made based on the voice recognition result to ON when the predetermined application is activated, wherein in the executing step, it is determined whether the instruction is based on the voice recognition result from the voice recognizing unit based on whether or not the flag is set to ON with reference to the flag.

Preferably, the control method according to the present invention further includes a step of, at the control unit, setting a flag representing that activation is made based on the voice recognition result to ON when activation of the predetermined application is requested from the voice recognizing unit, wherein in the executing step, it is determined whether the instruction is based on the voice recognition result from the voice recognizing unit based on whether or not the flag is set to ON with reference to the flag.

### Effects of the Invention

According to the present invention, a simple interface can be implemented when voice recognition is used in an electronic device.

### BRIEF DESCRIPTION OF THE DRAWINGS

FIG. 1 is an outer appearance perspective view of a cellular telephone device according to a first embodiment;

FIG. 2 is a block diagram illustrating a function of the cellular telephone device according to the first embodiment;

FIG. 3 is a diagram illustrating a screen transition example when a switching process of a user interface according to the first embodiment is not performed;

FIG. 4 is a diagram illustrating a screen transition example when a switching process of a user interface according to the first embodiment is performed;

FIG. 5 is a flowchart illustrating a process of the cellular telephone device according to the first embodiment;

FIG. 6 is a block diagram illustrating a function of a cellular telephone device according to a second embodiment;

FIG. 7 is a flowchart illustrating a process of the cellular telephone device according to the second embodiment;

FIG. 8 is a block diagram illustrating a function of a cellular telephone device according to a third embodiment;

FIG. 9 is a flowchart illustrating a process of the cellular telephone device according to the third embodiment;

FIG. 10 is a block diagram illustrating a function of a cellular telephone device according to a fourth embodiment; and

FIG. 11 is a flowchart illustrating a process of the cellular telephone device according to the fourth embodiment.

### PREFERRED MODE FOR CARRYING OUT THE INVENTION

### First Embodiment

Hereinafter, a first embodiment of the present invention will be described. In the present embodiment, a cellular telephone device 1 is described as an example of an electronic device.

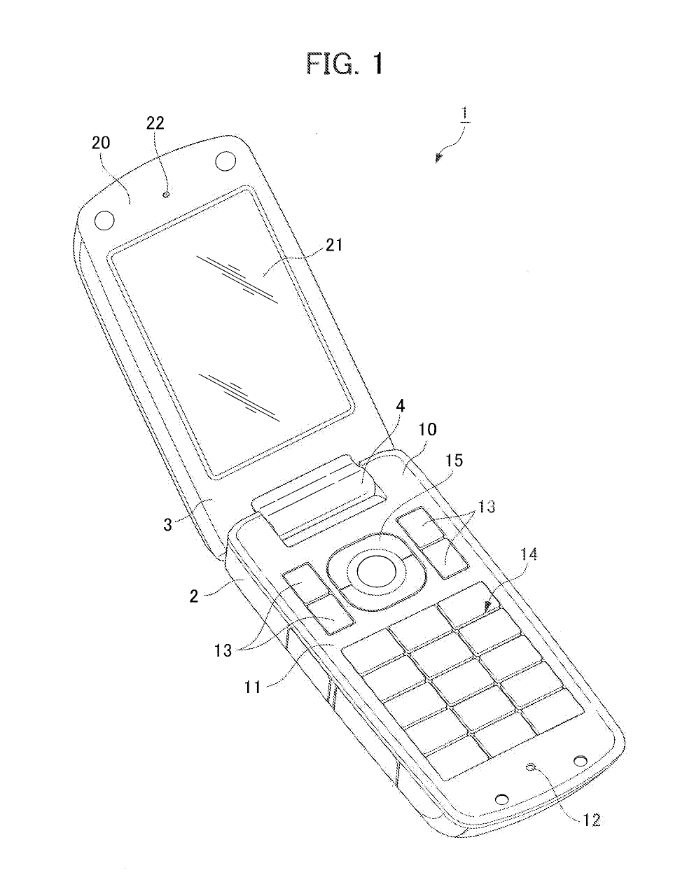

FIG. 1 is an outer appearance perspective view of a cellular telephone device 1 (electronic device) according to the present embodiment.

The cellular telephone device 1 includes an operating unit side body 2 and a display unit side body 3. The operating unit side body 2 includes an operating unit 11 and a microphone 12 to which a voice uttered by a user of the cellular telephone device 1 is input during a call or when a voice recognition application is used, which are arranged in a surface portion 10. The operating unit 11 includes function setting operation buttons 13 for activating various functions such as various setting functions, an address book function, and a mail function, input operation buttons 14 for inputting numbers of a phone number, characters of a mail, or the like, and decision operation buttons 15 for making a decision in various operations or for performing a scroll operation.

The display unit side body 3 includes a display unit 21 for displaying various pieces of information and a receiver 22 for outputting a voice of a communication counterpart side, which are arranged in a surface portion 20.

An upper end portion of the operating unit side body 2 is coupled with a lower end portion of the display unit side body 3 via a hinge mechanism 4. The cellular telephone device 1 can become a state (an open state) in which the operating unit side body 2 and the display unit side body 3 are opened to each other or a state (a folded state) in which the operating unit side body 2 and the display unit side body 3 are folded by relatively rotating the operating unit side body 2 and the display unit side body 3 which are coupled via the hinge mechanism 4.

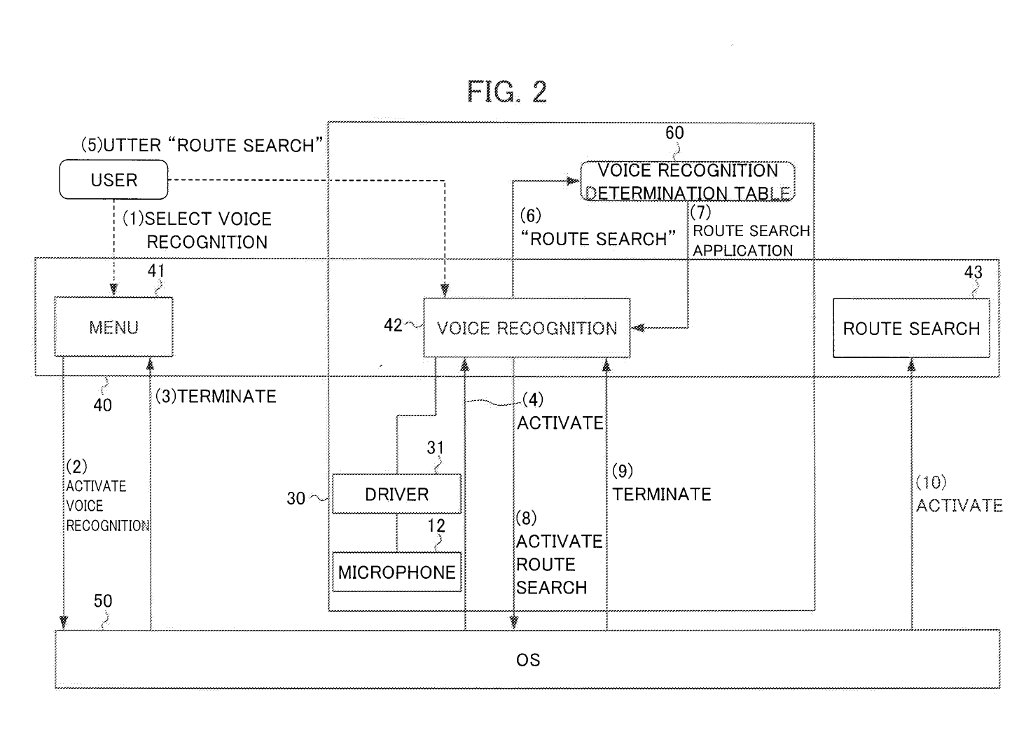

FIG. 2 is a block diagram illustrating a function of the cellular telephone device 1 according to the present embodiment.

The cellular telephone device 1 includes a voice recognizing unit 30, an executing unit 40, an operating system (OS) 50 (control unit).

The voice recognizing unit 30 includes the microphone 12, a driver 31, a voice recognition application 42, and a voice recognition determination table 60.

The driver 31 processes a voice signal input from the microphone 12 under control of the OS 50, and outputs the processed signal to the voice recognition application 42.

The voice recognition application 42 receives a voice input signal based on the user's voice from the driver 31, compares a voice recognition result with the voice recognition determination table 60, and decides an application or processing to activate. The voice recognition application 42 is one of applications executed by the executing unit 40.

Here, the voice recognition determination table 60 stores registered names “address book”, “mail”, “route search”, “photograph”, “Internet”, and the like in association with an address book application, an e-mail application, a route search application, a camera application, a browser application, and the like, respectively.

The voice recognition application 42 transfers a parameter representing that activation is made based on a voice recognition result to the OS 50 when instructing the OS 50 to activate a decided application.

The executing unit 40 executes various applications, installed in the cellular telephone device 1, such as a menu application 41, the voice recognition application 42, and a route search application 43 under control of the OS 50.

The OS 50 controls the cellular telephone device 1 in general and controls the voice recognizing unit 30 and the executing unit 40 such that a plurality of applications installed in the cellular telephone device 1 are selectively activated. Specifically, the OS 50 informs the executing unit 40 of an application to be activated based on an instruction from the voice recognizing unit 30 (the voice recognition application 42). At this time, the OS 50 transfers the parameter, which represents that activation is made based on a voice recognition result, transferred from the voice recognizing unit 30 (the voice recognition application 42) to the executing unit 40.

When an instruction to activate an application is given by the OS 50, the executing unit 40 determines whether or not the instruction is based on the voice recognition result from the voice recognizing unit 30 based on the parameter, and selects a processing content according to the determination result. That is, when an application is activated not based on the voice recognition result, the executing unit 40 provides a key input user interface using the operating unit 11. However, when an application is activated based on the voice recognition result, the executing unit 40 switches the user interface from the key input user interface to a voice input user interface.

Specifically, the executing unit 40 automatically activates the voice recognition application 42 as the voice input user interface. This enables an operation by a voice input to be continuously performed without requesting the user of the cellular telephone device 1 to input a key.

A process of activating the route search application 43 will be described below as an example.

In (1), the menu application 41 activated by the executing unit 40 receives selection of voice recognition by the user's key operation or the like.

In (2), the menu application 41 instructs the OS 50 to activate the voice recognition application 42.

In (3), the OS 50 instructs the executing unit 40 to terminate execution of the menu application 41 before activating the voice recognition application 42.

In (4), the OS 50 instructs the executing unit 40 to activate the voice recognition application 42.

In (5), the user utters “route search”. The voice recognition application 42 receives the voice input through the microphone 12 and the driver 31.

In (6), the voice recognition application 42 acquires a character string “route search” as a voice recognition result, and compares the character string with the voice recognition determination table 60.

In (7), as a result of comparing the voice recognition result with the registered name of the voice recognition determination table 60, the voice recognition application 42 acquires the route search application 43 corresponding to the registered name matching the character string “route search” as an application to be activated.

In (8), the voice recognition application 42 instructs the OS 50 to activate the route search application 43, and transfers the parameter representing that activation is made based on a voice recognition result to the OS 50.

In (9), the OS 50 instructs the executing unit 40 to terminate execution of the voice recognition application 42 before activating the route search application 43.

In (10), the OS 50 transfers the parameter representing that activation is made based on a voice recognition result to the executing unit 40, and instructs the executing unit 40 to activate the route search application 43. The route search application 43 determines that activation has been made based on the voice recognition result with reference to the received parameter, and thus provides the voice input user interface.

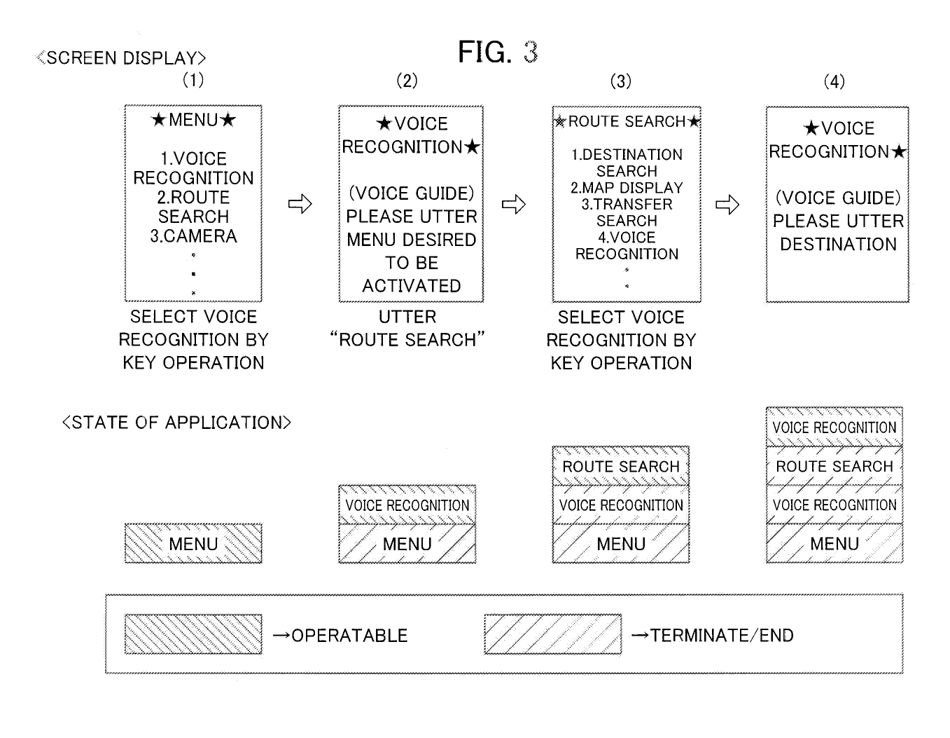

FIG. 3 is a diagram illustrating a screen transition example when a switching process of a user interface according to the present embodiment is not performed.

In this case, when the user selects voice recognition by a key operation in a screen (1) of the menu application 41, the voice recognition application 42 is activated, and the menu application 41 is terminated (2).

Here, when the user utters “route search”, the route search application 43 is activated based on the voice recognition result, and the voice recognition application 42 is terminated. At this time, a regular menu which is an initial screen of the route search application 43 is displayed (3).

When it is desired to further perform an operation by voice recognition, the user selects voice recognition by a key operation in the regular menu and activates the voice recognition application 42 again (4).

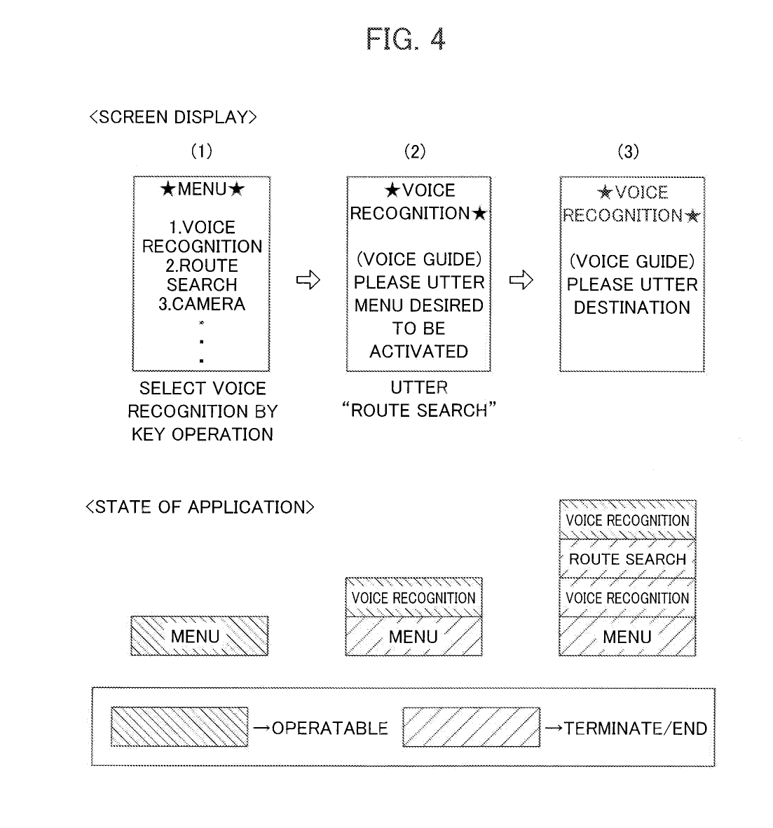

FIG. 4 is a diagram illustrating a screen transition example when a switching process of a user interface according to the present embodiment is performed.

In this case, when the user selects voice recognition by a key operation in a screen (1) of the menu application 41, the voice recognition application 42 is activated, and the menu application 41 is terminated (2).

Here, when the user utters “route search”, the route search application 43 is activated based on the voice recognition result, and the voice recognition application 42 is terminated. Further, when the activated route search application 43 determines that activation has been made based on the voice recognition result with reference to the parameter representing that activation is made based on a voice recognition result, the activated route search application 43 automatically activates the voice recognition application 42 and enters an utterance standby state for destination utterance by the user (3).

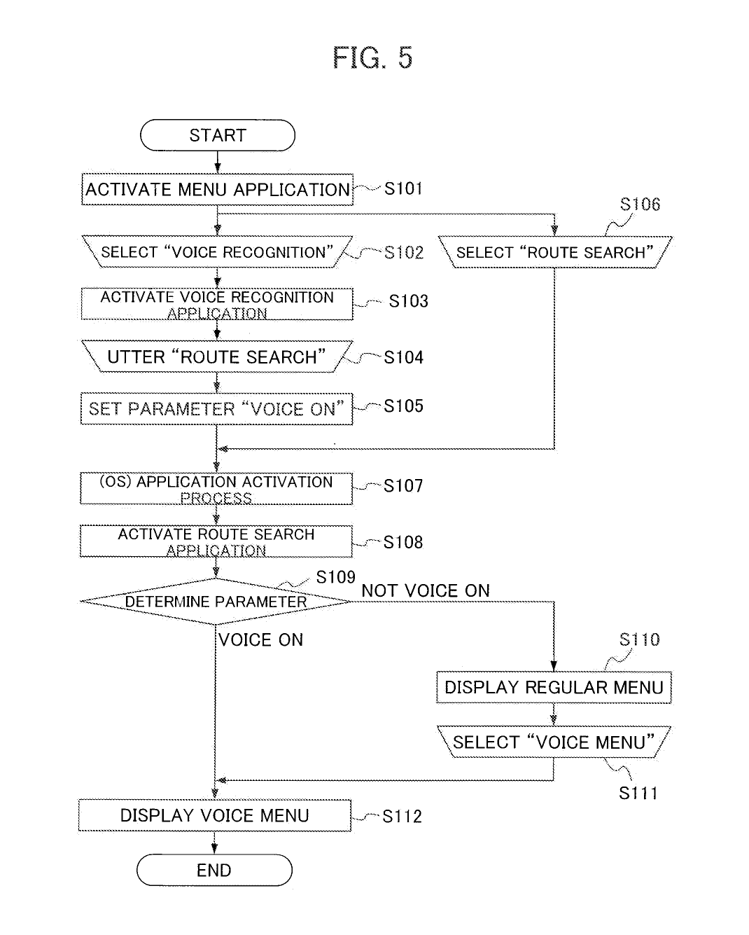

FIG. 5 is a flowchart illustrating a process of the cellular telephone device 1 according to the present embodiment.

In step S101, the menu application 41 is activated under control of the OS 50.

The menu application 41 receives a selection input of a plurality of processes by a key operation. A case where selection of “voice recognition” is received (step S102) and a case where selection of “route search” is received (step S106) are respectively described below.

When the menu application 41 receives selection of “voice recognition” in step S102, in step S103, the voice recognition application 42 is activated under control of the OS 50.

In step S104, the user utters “route search”, and so the voice recognition application 42 decides to activate the route search application 43 according to the voice recognition result.

In step S105, the voice recognition application 42 sets a parameter (“voice ON”) representing that an application is activated based on a voice recognition result, and instructs the OS 50 to activate an application

Meanwhile, when the menu application 41 receives selection of “route search” in step S106, the parameter (“voice ON”) is not set, and the process proceeds to step S107.

In step S107, the OS 50 controls the executing unit 40 based on the instruction from the menu application 41 or the voice recognition application 42 such that an activation process of the route search application 43 is performed. At this time, the OS 50 transfers the parameter (“voice ON”) to the executing unit 40.

In step S108, the executing unit 40 activates the route search application 43 according to control of the OS 50 in step S107.

In step S109, the route search application 43 refers to the parameter transferred from the OS 50 and determines whether or not the parameter represents “voice ON”. When the parameter represents “voice ON”, the route search application 43 proceeds to step S112, whereas when the parameter does not represent “voice ON”, the route search application 43 proceeds to step S110.

In step S110, the route search application 43 displays a regular menu and receives a key operation input from the user.

In step S111, the route search application 43 receives a selection input of “voice menu” from the user.

In step S112, the route search application 43 displays a voice menu which is the voice input user interface. For example, the route search application 43 may activate the voice recognition application 42 using the voice menu as described above and then receive an operation by a voice input.

According to the present embodiment, when the voice recognition function is used in the cellular telephone device 1, the voice input user interface is continuously provided even by an application newly activated based on a voice recognition result, and thus a simple interface can be implemented. That is, convenience of the user who uses the voice recognition function is improved.

### Second Embodiment

Next, a second embodiment of the present invention will be described. In the present embodiment, a voice recognition use flag 70 (which will be described later) referred to by the OS 50 is further used. The same components as in the first embodiment are denoted by the same reference numerals, and thus a description thereof will be simplified or will not be repeated.

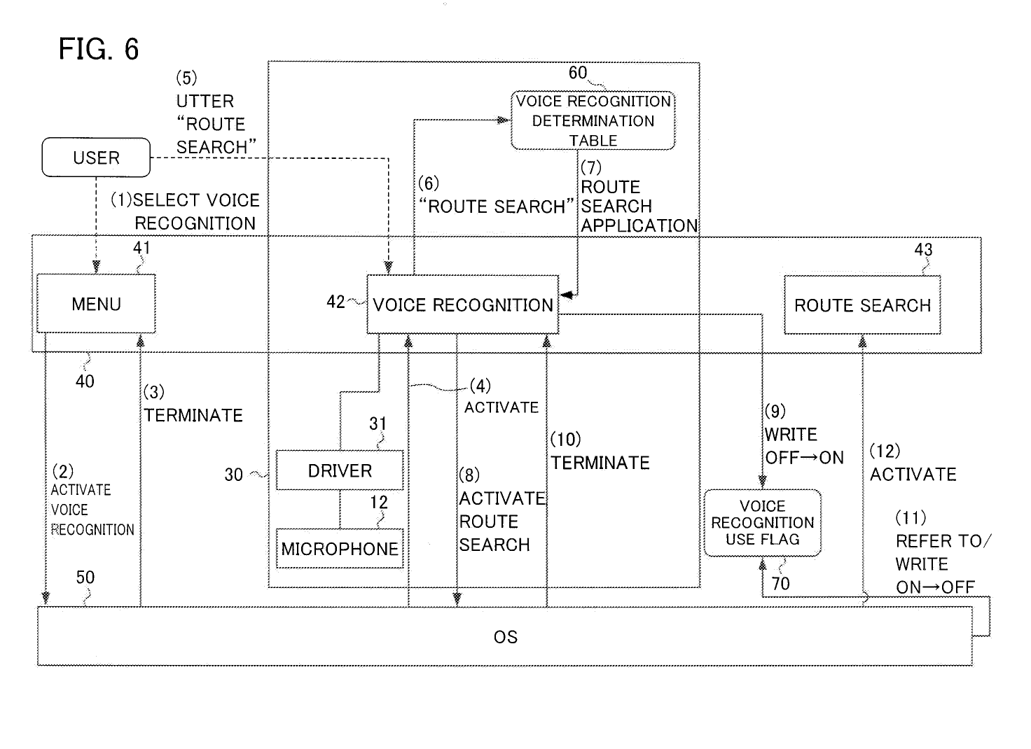

FIG. 6 is a block diagram illustrating a function of the cellular telephone device 1 according to the present embodiment.

The voice recognition application 42 writes a voice recognition use flag 70 representing that activation is made based on a voice recognition result when instructing the OS 50 to activate a decided application.

The OS 50 informs the executing unit 40 of an application to be activated based on the instruction from the voice recognizing unit 30 (the voice recognition application 42). At this time, the OS 50 refers to the voice recognition use flag 70 and transfers the parameter, which represents that activation is made based on a voice recognition result, to the executing unit 40 when the flag remains set.

When an instruction to activate an application is given by the OS 50, the executing unit 40 determines whether or not the instruction is based on the voice recognition result from the voice recognizing unit 30 based on the parameter, and selects a processing content according to the determination result. That is, when an application is activated not based on a voice recognition result, the executing unit 40 provides the key input user interface using the operating unit 11. However, when an application is activated based on the voice recognition result, the executing unit 40 switches the user interface from the key input user interface to the voice input user interface.

A process of activating the route search application 43 will be described below as an example.

(1) to (7) are the same as in the first embodiment (FIG. 2), and the route search application 43 is decided as an application to be activated.

In (8), the voice recognition application 42 instructs the OS 50 to activate the route search application 43.

In (9), the voice recognition application 42 changes the voice recognition use flag 70 representing that activation is made based on a voice recognition result from “OFF” to “ON”, and writes the changed voice recognition use flag 70.

In (10), the OS 50 instructs the executing unit 40 to terminate execution of the voice recognition application 42 before activating the route search application 43.

In (11), the OS 50 refers to the voice recognition use flag 70. When the flag represents “ON”, the OS 50 changes the flag “ON” to “OFF” in preparation for a next application activation process.

In (12), the OS 50 instructs the executing unit 40 to activate the route search application 43. At this time, when the voice recognition use flag 70 referred to in (11) represents “ON”, the OS 50 transfers the parameter representing that activation is made based on a voice recognition result to the executing unit 40. The route search application 43 determines that activation has been made based on the voice recognition result with reference to the received parameter, and thus provides the voice input user interface.

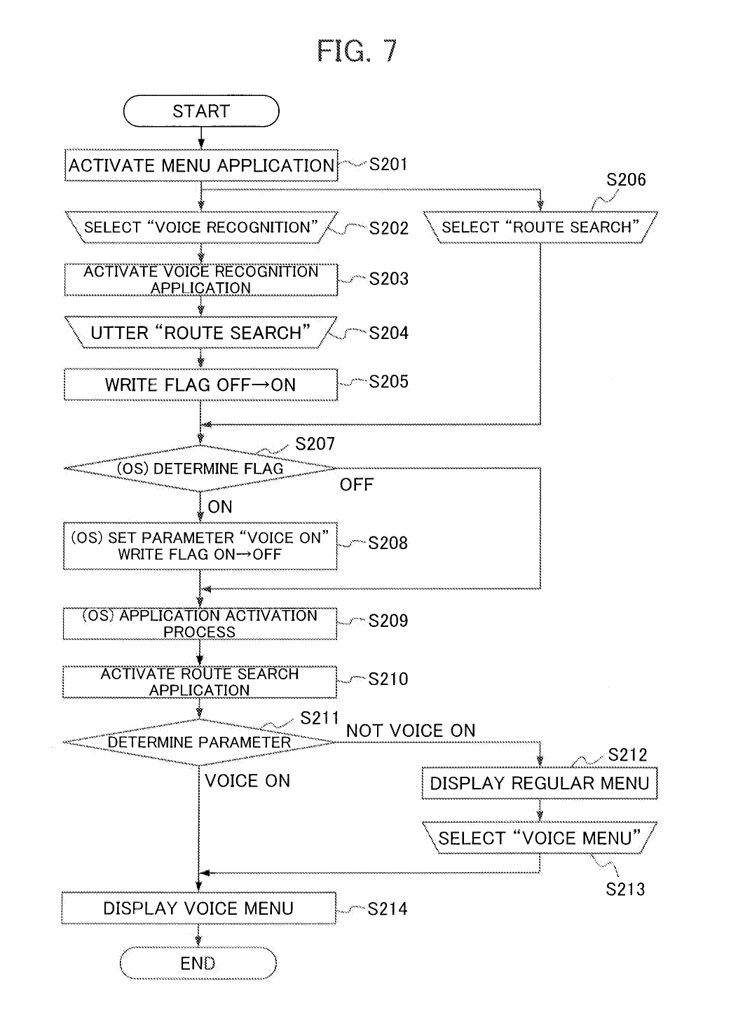

FIG. 7 is a flowchart illustrating a process of the cellular telephone device 1 according to the present embodiment.

Steps S201 to S204 and step S206 are the same as steps S101 to S104 and step S106 of the first embodiment (FIG. 5), respectively, and activation of the route search application 43 is selected.

In step S205, the voice recognition application 42 changes the voice recognition use flag 70 representing that an application is activated based on a voice recognition result from “OFF” to “ON”, writes the changed voice recognition use flag 70, and instructs the OS 50 to activate an application.

When the menu application 41 receives selection of “route search” in step S206, the voice recognition use flag 70 is not written (remains “OFF”), and the process proceeds to step S207.

In step S207, the OS 50 determines whether the flag represents “ON” or “OFF” with reference to the voice recognition use flag 70. When the flag represents “ON”, the OS 50 causes the process to proceed to step S208, whereas when the flag represents “OFF”, the OS 50 causes the process to proceed to step S209.

In step S208, the OS 50 sets the parameter (“voice ON”) representing that an application is activated based on a voice recognition result. Further, the OS 50 changes the voice recognition use flag 70 from “ON” to “OFF” in preparation for a next application activation process.

In step S209, the OS 50 controls the executing unit 40 such that an activation process of the route search application 43 is performed. At this time, the OS 50 transfers the parameter (“voice ON”) to the executing unit 40.

In step S210, the executing unit 40 activates the route search application 43 according to control of the OS 50 in step S209.

Steps S211 to step S214 are the same as steps S109 to S112 of the first embodiment (FIG. 5), respectively. That is, the route search application 43 refers to the parameter transferred from the OS 50. At this time, when the parameter represents “voice ON”, the route search application 43 displays the voice menu which is the voice input user interface. However, when the parameter does not represent “voice ON”, the route search application 43 displays the regular menu and receives a selection input of “voice menu” from the user. For example, the route search application 43 may activate the voice recognition application 42 using the voice menu as described above and then receive an operation by a voice input.

### Third Embodiment

Next, a third embodiment of the present invention will be described. In the present embodiment, an application (the route search application 43) to be activated is provided with a function of referring to and writing the voice recognition use flag 70 instead of the OS 50 in the second embodiment. The same components as in the first or second embodiment are denoted by the same reference numerals, and thus a description thereof will be simplified or will not be repeated.

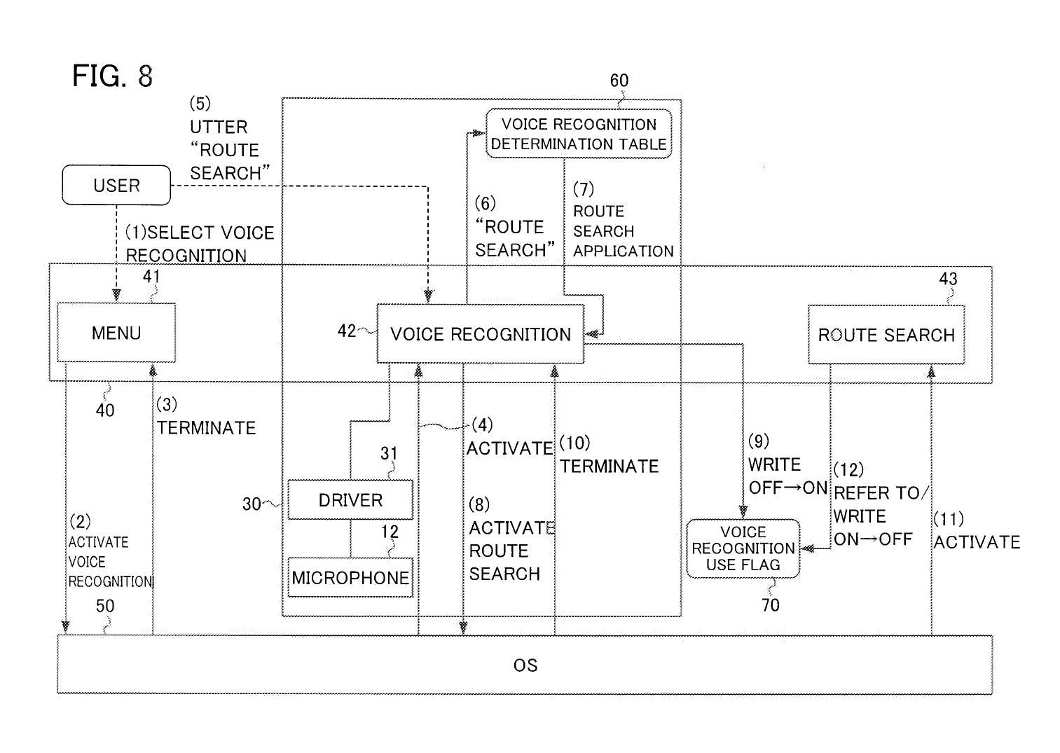

FIG. 8 is a block diagram illustrating a function of the cellular telephone device 1 according to the present embodiment.

The voice recognition application 42 writes the voice recognition use flag 70 representing that activation is made based on a voice recognition result when instructing the OS 50 to activate a decided application.

The OS 50 informs the executing unit 40 of an application to be activated based on the instruction from the voice recognizing unit 30 (the voice recognition application 42). At this time, the OS 50 needs not refer to the voice recognition use flag 70 and gives the same instruction to the executing unit 40 regardless of whether or not activation is made based on a voice recognition result.

When an instruction to activate an application is given by the OS 50, the executing unit 40 determines whether or not the instruction is based on the voice recognition result by the voice recognizing unit 30 based on whether the voice recognition use flag 70 represents “ON” or “OFF”, and selects a processing content according to the determination result. That is, when an application is activated not based on the voice recognition result, the executing unit 40 provides the key input user interface using the operating unit 11. However, when an application is activated based on the voice recognition result, the executing unit 40 switches the user interface from the key input user interface to the voice input user interface.

A process of activating the route search application 43 will be described below as an example.

(1) to (10) are the same as in the second embodiment (FIG. 6). Before the route search application 43 is activated based on the voice recognition result, the voice recognition use flag 70 is written, and the voice recognition application 42 is terminated.

In (11), the OS 50 instructs the executing unit 40 to activate the route search application 43.

In (12), the route search application 43 refers to the voice recognition use flag 70. When the flag represents “ON”, the route search application 43 determines that activation has been made based on the voice recognition result, and provides the voice input user interface. Further, the route search application 43 changes the voice recognition use flag 70 from “ON” to “OFF” in preparation for a next application activation process.

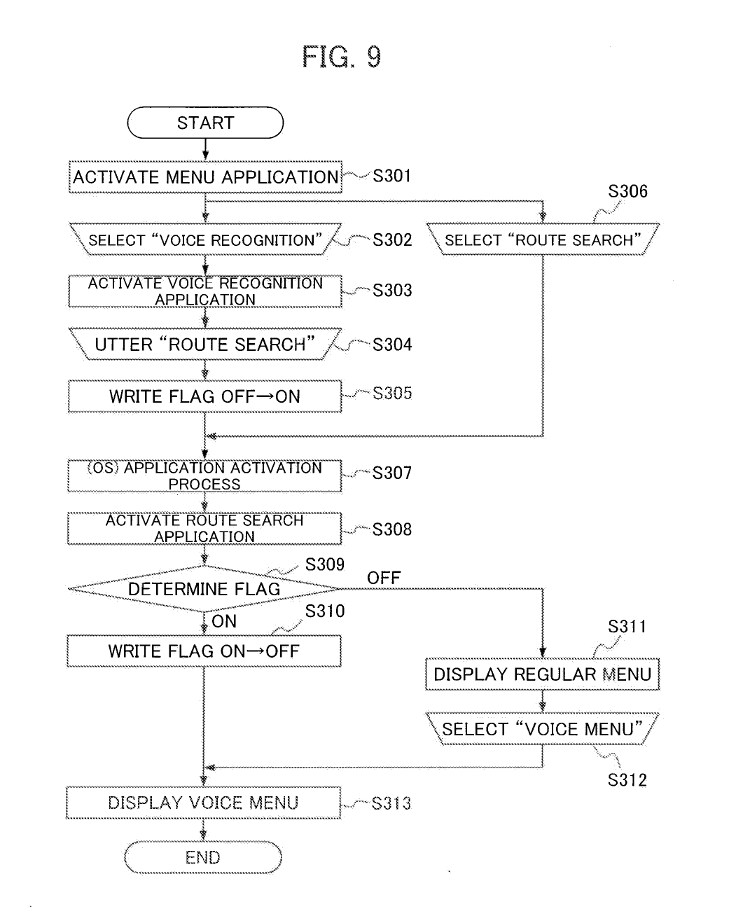

FIG. 9 is a flowchart illustrating a process of the cellular telephone device 1 according to the present embodiment.

Steps S301 to S306 are the same as steps S201 to S206 of the second embodiment (FIG. 7), respectively. Based on the instruction from the menu application 41 or the voice recognition application 42, activation of the route search application 43 is selected, and the voice recognition use flag 70 is set.

In step S307, the OS 50 controls the executing unit 40 based on the instruction from the menu application 41 or the voice recognition application 42 such that the activation process of the route search application 43 is performed.

In step S308, the executing unit 40 activates the route search application 43 according to control of the OS 50 in step S307.

In step S309, the route search application 43 refers to the voice recognition use flag 70 and determines whether the flag represents “ON” or “OFF”. When the flag represents “ON”, the route search application 43 causes the process to proceed to step S310, whereas when the flag represents “OFF”, the route search application 43 causes the process to proceed to step S311.

In step S310, the route search application 43 changes the voice recognition use flag 70 from “ON” to “OFF” in preparation for a next application activation process.

Steps S311 to S313 are the same as steps S212 to S214 of the second embodiment (FIG. 7), respectively. When it is determined in step S309 that the flag represents “ON”, the route search application 43 displays the voice menu which is the voice input user interface. However, when it is determined in step S309 that the flag represents “OFF”, the route search application 43 displays the regular menu and receives a selection input of “voice menu” from the user. For example, the route search application 43 may activate the voice recognition application 42 using the voice menu as described above and then receive an operation by a voice input.

According to the present embodiment, even when the switching process of the user interface is performed based on the voice recognition result, the OS 50 may have the same configuration as when the switching process of the user interface is not performed. Thus, the cellular telephone device 1 is slightly modified compared to the first embodiment and the second embodiment, and the present invention can be implemented only by modification of an application.

### Fourth Embodiment

Next, a fourth embodiment of the present invention will be described. The present embodiment is different from the above embodiments in that the voice recognition use flag 70 is written by the OS 50. The same components as in the first to third embodiments are denoted by the same reference numerals, and thus a description thereof will be simplified or will not be repeated.

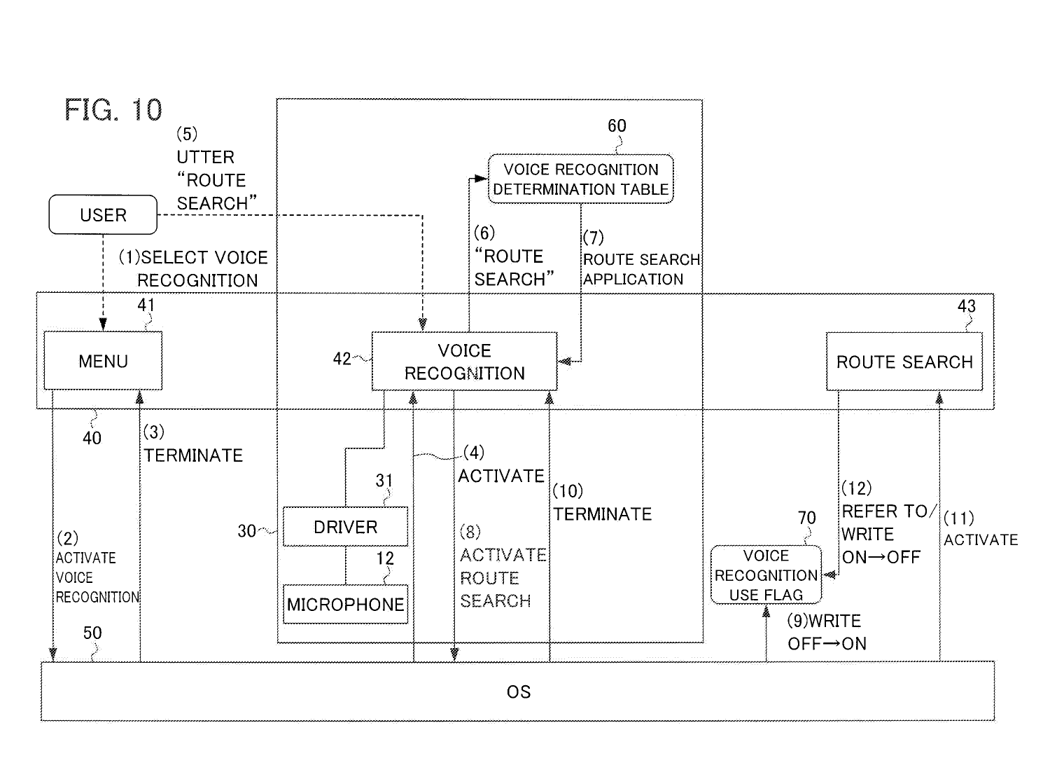

FIG. 10 is a block diagram illustrating a function of the cellular telephone device 1 according to the present embodiment.

The voice recognition application 42 transfers the parameter representing that activation is made based on a voice recognition result when instructing the OS 50 to activate a decided application.

The OS 50 informs the executing unit 40 of an application to be activated based on the instruction from the voice recognizing unit 30 (the voice recognition application 42). At this time, the OS 50 writes the voice recognition use flag 70.

When an instruction to activate an application is given by the OS 50, the executing unit 40 determines whether or not the instruction is based on the voice recognition result from the voice recognizing unit 30 based on whether the voice recognition use flag 70 represents “ON” or “OFF”, and selects a processing content according to the determination result. That is, when an application is activated not based on a voice recognition result, the executing unit 40 provides the key input user interface using the operating unit 11. However, when an application is activated based on the voice recognition result, the executing unit 40 switches the user interface from the key input user interface to the voice input user interface.

A process of activating the route search application 43 will be described below as an example.

(1) to (8) are the same as in the first embodiment (FIG. 2). The route search application 43 is decided as an application to be activated. An instruction to activate an application is transferred to the OS 50 together with the parameter representing that activation is made based on a voice recognition result.

In (9), the OS 50 changes the voice recognition use flag 70 representing that an application is activated based on a voice recognition result from “OFF” to “ON” according to the received parameter, and writes the changed voice recognition use flag 70.

In (10), the OS 50 instructs the executing unit 40 to terminate execution of the voice recognition application 42 before activating the route search application 43.

In (11), the OS 50 instructs the executing unit 40 to activate the route search application 43.

In (12), the route search application 43 refers to the voice recognition use flag 70. When the flag represents “ON”, the route search application 43 determines that activation has been made based on a voice recognition result, and provides the voice input user interface. Further, the route search application 43 changes the voice recognition use flag 70 from “ON” to “OFF” in preparation for a next application activation process.

The OS 50 may change the voice recognition use flag 70 from “ON” to “OFF” at predetermining timing (for example, timing when execution of the route search application 43 ends or terminates) after activation of the route search application 43.

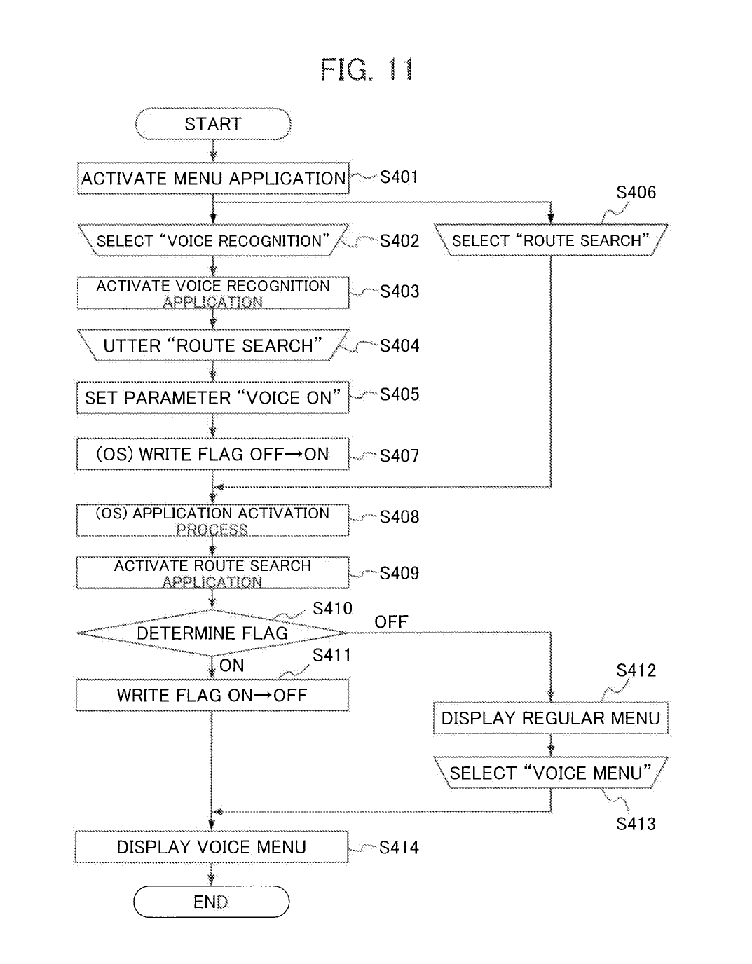

FIG. 11 is a flowchart illustrating a process of the cellular telephone device 1 according to the present embodiment.

Steps S401 to S406 are the same as steps S101 to S106 of the first embodiment (FIG. 5), respectively. Based on an instruction from the menu application 41 or the voice recognition application 42, activation of the route search application 43 is selected, the parameter representing whether or not activation is made based on a voice recognition result is set, and an instruction to activate an application is transferred to the OS 50.

In step S407, the OS 50 changes the voice recognition use flag 70 representing that an application is activated based on a voice recognition result from “OFF” to “ON”, and writes the changed voice recognition use flag 70. When the menu application 41 receives selection of “route search” in step S406, the flag is not changed (remains “OFF”), and the process proceeds to step S408.

Steps S408 to S414 are the same as steps S307 to S313 of the third embodiment (FIG. 9). That is, when it is determined that the flag represents “ON” based on the voice recognition use flag 70, the route search application 43 displays the voice menu which is the voice input user interface. However, when it is determined that the flag represents “OFF”, the route search application 43 displays the regular menu and receives a selection input of “voice menu” from the user. For example, the route search application 43 may activate the voice recognition application 42 using the voice menu as described above and then receive an operation by a voice input.

According to the present embodiment, since the voice recognition use flag 70 is written by the OS 50, the present invention can be implemented by slight or few modification of an existing voice recognition application. Furthermore, when the OS 50 is configured to perform the process of changing the voice recognition use flag 70 from “ON” to “OFF”, an application (the route search application 43) to be activated is normally executed even though it is an existing application that does not support the switching process of the user interface.

### Modified Example

The exemplary embodiments have been described hereinbefore. However, the present invention is not limited to the above embodiments and can be implemented in various forms. Further, the effects described in the above embodiments are exemplary effects obtained from the present invention, and the effects of the present invention are not limited to the above-described effects.

In the above embodiment, activation of the voice recognition application 42 is described as a modified example of the user interface, but the present invention is not limited thereto.

For example, the executing unit 40 may display not a regular menu premised on a key operation but a menu, which gives the user's convenience priority, using voice recognition, text to speech (TTS), or the like, that is, a voice user menu.

Further, the executing unit 40 may change various settings or an execution mode of the cellular telephone device 1 after activation is made based on a voice recognition result. Specifically, the executing unit 40 may make a setting for causing TTS to be automatically performed or may display a shortcut menu on only a processing item frequently used by the user using voice recognition.

Particularly, when an application to be activated is a browser application, the executing unit 40 may allow a connection to previously set other site different from a requested destination site in order to prevent a connection to a site including contents or characters on which a TTS function or a voice recognition function are hardly used. Further, the executing unit 40 may not display an image (a still image or a moving picture) in order to reduce a time taken until operation of TTS or voice recognition is enabled.

Further, in the above embodiments, the cellular telephone device 1 has been described as an electronic device. However, the electronic device is not limited thereto, and the present invention can be applied to various electronic devices such as a personal handy phone system (PHS), a personal digital assistant (PDA), a game machine, a navigation device, and a personal computer (PC).

Furthermore, in the above embodiments, the cellular telephone device 1 is of a type that is foldable by the hinge mechanism 4, but the present invention is not limited thereto. Besides a folder type, the cellular telephone device 1 may be of a slide type in which one body slides in one direction in a state in which the display unit side body 3 is superimposed on the operating unit side body 2, a rotary (turn) type in which one body rotates on an axis line in a superimposition direction of the operating unit side body 2 and the display unit side body 3, or a type (straight type) in which the operating unit side body 2 and the display unit side body 3 are arranged on one body without a coupling unit. Further, the cellular telephone device 1 may be of a 2-axis hinge type that is openable and rotatable.

### EXPLANATION OF REFERENCE NUMERALS

1 cellular telephone device

12 microphone

30 voice recognizing unit

31 driver

40 executing unit

41 menu application

42 voice recognition application

43 route search application

50 OS

60 voice recognition determination table

70 voice recognition use flag

1. An electronic device, comprising: a voice recognizing unit;
an executing unit that executes a predetermined application; and
a control unit that controls the voice recognizing unit and the executing unit,
wherein when an activation instruction of the predetermined application is received from the control unit, the executing unit determines whether or not the activation instruction is an instruction based on a voice recognition result from the voice recognizing unit, and selects a processing content according to the determination result.

2. The electronic device according to claim 1, wherein the executing unit changes a user interface of the predetermined application to a voice input user interface when the activation instruction is an instruction based on the voice recognition result.

3. The electronic device according to claim 2, wherein the control unit activates the voice recognizing unit when the executing unit changes the user interface to the voice input user interface.

4. The electronic device according to claim 1, wherein a parameter representing that the predetermined application is activated based on the voice recognition result as the activation instruction is transferred from the voice recognizing unit to the executing unit via the control unit.

5. The electronic device according to claim 1, wherein the voice recognizing unit sets a flag representing that activation is made based on the voice recognition result to ON when the predetermined application is activated, and
when it is determined that the flag is set to ON with reference to the flag, the control unit transfers a parameter as the activation instruction representing that the predetermined application is activated based on the voice recognition result to the executing unit.

6. The electronic device according to claim 1, wherein the voice recognizing unit sets a flag representing that activation is made based on the voice recognition result to ON when the predetermined application is activated, and
the executing unit determines whether the instruction is based on the voice recognition result from the voice recognizing unit based on whether or not the flag is set to ON with reference to the flag.

7. The electronic device according to claim 1, wherein the control unit sets a flag representing that activation is made based on the voice recognition result to ON when activation of the predetermined application is requested from the voice recognizing unit, and
the executing unit determines whether the instruction is based on the voice recognition result from the voice recognizing unit based on whether or not the flag is set to ON with reference to the flag.

8. A control method in an electronic device including a voice recognizing unit, an executing unit that executes a predetermined application, and a control unit that controls the voice recognizing unit and the executing unit, the method comprising:
an executing step of, at the executing unit, when an activation instruction of the predetermined application is received from the control unit, determining whether or not the activation instruction is an instruction based on a voice recognition result from the voice recognizing unit, selecting a processing content according to the determination result, and executing the predetermined application.

9. The control method according to claim 8, wherein in the executing step, a user interface of the predetermined application is changed to a voice input user interface when the activation instruction is an instruction based on the voice recognition result.

10. The control method according to claim 9, further comprising a step of, at the control unit, activating the voice recognizing unit when the user interface is changed to the voice input user interface in the executing step.

11. The control method according to claim 8, further comprising a step of transferring a parameter representing that the predetermined application is activated based on the voice recognition result as the activation instruction from the voice recognizing unit to the executing unit via the control unit.

12. The control method according to claim 8, further comprising:
a step of, at the voice recognizing unit, setting a flag representing that activation is made based on the voice recognition result to ON when the predetermined application is activated; and
a step of, when it is determined that the flag is set to ON with reference to the flag, at the control unit, transferring a parameter as the activation instruction representing that the predetermined application is activated based on the voice recognition result to the executing unit.

13. The control method according to claim 8, further comprising a step of, at the voice recognizing unit, setting a flag representing that activation is made based on the voice recognition result to ON when the predetermined application is activated,
wherein in the executing step, it is determined whether the instruction is based on the voice recognition result from the voice recognizing unit based on whether or not the flag is set to ON with reference to the flag.

14. The control method according to claim 8, further comprising a step of, at the control unit, setting a flag representing that activation is made based on the voice recognition result to ON when activation of the predetermined application is requested from the voice recognizing unit,
wherein in the executing step, it is determined whether the instruction is based on the voice recognition result from the voice recognizing unit based on whether or not the flag is set to ON with reference to the flag.
